(19) United States
(12) Patent Application Publication
(10) Pub. No.: US 2007/0048726 A1
(43) Pub. Date: Mar. 1, 2007

(54) Methods and Compositions for the Control of Molecular-Based Cell Death During Preservation of Cells, Tissues or Organs in a Gel-Like State

(75) Inventors: John M. Baust, Owego, NY (US); Robert Van Buskirk, Apalachin, NY (US); John G. Baust, Candor, NY (US); Kristi K. Snyder, Vestal, NY (US); Aby J. Mathew, Vestal, NY (US)

Correspondence Address: BROWN & MICHAELS, PC;400 M & T BANK BUILDING, 118 NORTH TIOGA ST, ITHACA, NY, 14850, US

(73) Assignee: BIOLIFE SOLUTIONS, INC., Owego, NY (US)

(21) Appl. No.: 11/553,245

(22) Filed: Oct. 26, 2006

Related U.S. Application Data
(63) Continuation-in-part of application No. 10/166,732, filed on Jun. 12, 2002, now abandoned.
(62) Division of application No. 09/757,694, filed on Jan. 11, 2001, now Pat. No. 6,632,666.
(60) Provisional application No. 60/176,009, filed on Jan. 14, 2000.

(51) Int. Cl. A01N 1/02

(52) U.S. Cl. 435/1.1; 435/2

(57) ABSTRACT

Gel-based medium compositions and a method of use thereof in normothermic, hypothermic or cryopreservative storage and transport of cell samples are described. These gel-based compositions preferably include an agent that inhibits apoptosis, together with a gelling agent. Such gel-based medium compositions protect various cell samples, such as animal or plant organs, tissues and cells, from the mechanical, physiological and biochemical stresses inherently associated with liquid preservation techniques.

### REFERENCE TO RELATED APPLICATIONS

This application is a continuation in part application of co-pending application Ser. No. 10/166,732, filed Jun. 12, 2002, entitled “NORMOTHERMIC, HYPOTHERMIC AND CRYOPRESERVATION MAINTENANCE AND STORAGE OF CELLS, TISSUES AND ORGANS IN GEL-BASED MEDIA”, which is a divisional patent application of application Ser. No. 09/757,694, filed Jan. 11, 2001, entitled “NORMOTHERMIC, HYPOTHERMIC AND CRYOPRESERVATION MAINTENANCE AND STORAGE OF CELLS, TISSUES AND ORGANS IN GEL-BASED MEDIA”, now U.S. Pat. No. 6,632,666, which claims an invention which was disclosed in Provisional Application No. 60/176,009, filed Jan. 14, 2000, entitled “NORMOTHERMIC, HYPOTHERMIC AND CRYOPRESERVATION MAINTENANCE AND STORAGE OF CELLS, TISSUES AND ORGANS IN GEL-BASED MEDIA”. The benefit under 35 USC §119(e) of the United States provisional application is hereby claimed, and the aforementioned applications and patents are hereby incorporated herein by reference.

### BACKGROUND OF THE INVENTION

1. Field of the Invention

The invention relates to the gel state preservation of cells, tissues and organs. In particular, the invention relates to the hypothermic preservation or storage of cells, tissues or organs in the semi-solid, gel-like state.

2. Description of Related Art

Today, limited normothermic, hypothermic and cryopreservative maintenance and storage of plant or mammalian cells, tissues and organs (biologics) is accomplished in liquid media. Success is limited, in part, due to damage that occurs during shipment (transport), most often associated with mechanical trauma.

Preservation and transport (herein referred to as preservation) of biologics (cells, tissues, and organs) has traditionally been achieved through “suspension” in a liquid preservation medium. These media include, but are not limited to a simple saline solution, cell culture media, and preservation solutions such as University of Wisconsin (UW) solution (Viaspan® solution), Euro-Collins™ solution, and Hypothermosol® solution (Bio Life Solutions, Inc., Owego, N.Y., USA). Inherent in this liquid preservation approach is that the liquid environment confers no physical support network for the biologic during preservation and transport. Due to this lack of physical support upon preservation, biologics are exposed to numerous physical stresses during storage and shipment. These stresses include, but are not limited to, sedimentation, mechanical “jarring”, compaction in a liquid column, shaking, vibration, shearing forces, ice damage, and the like. As a result of these mechanical stresses plus additional biochemical stresses inherently associated with biologic preservation in liquid, a significant level of cellular death is initiated during and following the preservation interval. Consequently, failure of the biologic ensues due to this preservation-initiated cell death.

The preservation of eukaryotic cells, tissues or organs is commonly carried out by chilling them sufficiently to slow or halt metabolic processes that require ongoing support by an organism or the environment to maintain viability. The preservation of cells, tissues or organs by such chilling is generally referred to as hypothermic preservation or hypothermic storage.

There are two broad types of hypothermic storage for cells, tissues or organs. The first involves storage at temperatures above the freezing point of the solution or medium in which the sample is suspended or immersed or with which the sample is perfused. For example, such temperatures may be in the range of about 10° C. to 0° C. Such conditions are appropriate only for short term storage, generally on the order of hours to several days to about a week.

The second broad type involves storage at lower temperatures, for example, as low as −80° C. to −196° C. Storage under these conditions is more appropriate for longer periods of time. In this second broad category, there are two general sub-classes of preservation approach. The first sub-class involves the freezing of the samples in a medium or solution that permits the formation of ice crystals. For this approach, cryoprotective agents (e.g., dimethyl sulfoxide (DMSO), glycerol) are added that mitigate the effect of the formation of ice crystals, essentially by causing dehydration of the cells that prevents intracellular water crystal formation. This approach is referred to herein as “cryopreservation.”

The basic challenge of hypothermic storage is to preserve the material in a state that can be reversed without causing extensive cell damage or cell death. Approaches (solutions and methods) that minimize the accumulation of sub-lethal damages such as oncotic balance, energy deprivation, cellular waste accumulation, ionic balance, as well as formation of ice crystals in or around cells are well known to aid in the survival and ultimate recovery of material stored at hypothermic temperatures. However, even when these factors are controlled, as in the case of hypothermic storage and cryopreservation, there remains an associated degree of cell death. Cell death is known to occur by two different mechanisms. The first, necrotic cell death or necrosis, is not mediated by a specific cellular pathway. Necrosis is characterized by the loss of cell membrane integrity resulting in cell swelling, and is caused by a number of pathological agents. DNA in cells that undergo necrosis is cleaved in a random fashion. Thus, the DNA from cells that have undergone necrosis appears as a continuous smear when subjected to gel electrophoresis. The second cell death mechanism, apoptosis or programmed cell death, is the result of the activation of a specific biochemical pathway involving a cascade of biochemical activation steps that ultimately result in the death of the cell. Apoptosis is characterized by cell shrinkage, intact plasma membranes, and non-random cleavage of DNA at an approximately 180 nucleotide interval, evidenced by a ladder of DNA cleavage products upon gel electrophoresis of genomic DNA. Apoptosis is reviewed, for example, by Kerr et al., 1994, Cancer 73: 2013 and Evan & Littlewood, 1998, Science 281: 1317.

Cell death accompanying hypothermic storage involves an apoptotic component. U.S. Pat. No. 6,045,990, incorporated herein by reference, demonstrates, in part, that survival and recovery from cryopreservation can be enhanced by the inclusion of anti-apoptotic agents in the preservation medium.

U.S. Pat. No. 6,921,633 discloses methods for the hypothermic preservation of cells, tissues and organs in the vitreous state. This preservation can only be accomplished at very low temperatures. Preservation of cells, tissues, and organs in a vitreous state requires the utilization of high concentrations of toxic agents coupled with controlled reduction of sample temperature to ultra-low temperatures (<−140° C.) to cause the formation of a glass (amorphous solid). The extent of cell survival following vitreous preservations can be significantly improved by the inclusion of anti-apoptotic agents into the preservation medium. This patent is incorporated herein by reference.

There is a need in the art for improved methods of hypothermic preservation over a wide range of temperatures.

### SUMMARY OF THE INVENTION

The present invention includes methods and compositions for the preservation of cells, tissues or organs in the semi-solid state.

The invention includes gel-based medium compositions for normothermic, hypothermic or cryopreservative transport and/or storage of plant tissues or cells and animal organs, tissues or cells. In one embodiment, the gel-based compositions include a cell maintenance and preservation medium and a gelling agent. In particular, mammalian samples, such as human and animal organs, tissues and cells, may be preserved in the gel-based media compositions. In a preferred embodiment, the cell maintenance and preservation medium is liquid.

In one embodiment, a method of preserving a eukaryotic cell, tissue or organ includes the step of contacting the cell, tissue or organ with a semi-solid, gel-like storage solution. The storage solution preferably includes a composition that inhibits the activation and progression of molecular-based cell death cascades (apoptosis and necrosis) and a concentration of a semi-solid gelling agent that is sufficient for gelling of the solution. The storage solution also preferably includes agents which protect cells from ice-related damage (including but not limited to dimethyl sulfoxide, glycerol, and propanediol). The method also includes the step of preserving the cell, tissue or organ, where the cell, tissue or organ becomes encapsulated within the semi-solid gel-state preservation matrix.

The molecular based cell death control during gel-state preservation is preferably accomplished through use of a hypothermic storage solution which contains a gelling agent and agents designed to inhibit the activation and progression of apoptotic and necrotic cell death cascades. The inclusion of one or more anti-apoptotic agents aids in preventing the apoptotic cell death that normally occurs subsequent to this type of preservation.

In one embodiment, the gel-state preservation is performed at a temperature of +37° C. to −0° C.

In another embodiment, the gel-state preservation is performed at a temperature of −1° C. to −196° C., and more preferably at a temperature of −80° C. to −196° C.

In another embodiment, the composition that inhibits apoptosis includes an agent that interacts with a polypeptide that participates in an apoptotic pathway. In one embodiment, the agent inhibits the activity of the polypeptide. In another embodiment, the agent maintains or potentiates the activity of the polypeptide.

In another embodiment, the agent is selected from the group consisting of a caspase inhibitor, a calpain inhibitor, and an inhibitor of nitrous oxide synthase. In another embodiment, the composition that inhibits apoptosis includes an antioxidant. In another embodiment, the composition that inhibits apoptosis includes an agent selected from the group consisting of a free radical scavenger, a zinc chelator, and a calcium chelator.

### BRIEF DESCRIPTION OF THE DRAWINGS

FIG. 1 graphically depicts post-storage recovery of MDCK (Madin Darby Canine Kidney) cells stored as monolayers in culture plates at 4° C. for 24 hours in liquid maintenance and preservation solutions (controls) (media, HTS, & HTS FRS) and in liquid maintenance and preservation solutions as gel formulations (HTS Gel & HTS FRS Gel).

FIG. 2 graphically depicts post-storage recovery of MDCK cells stored as monolayers in culture plates at 4° C. for 3 days in liquid maintenance and preservation solutions (controls) (media, HTS, & HTS FRS) and in liquid maintenance and preservation solutions as gel formulations (HTS Gel & HTS FRS Gel).

FIG. 3 graphically depicts post-storage recovery of MDCK cells stored in suspension in culture plates at 4° C. for 24 hours in liquid maintenance and preservation solutions (controls) (media, HTS, & HTS FRS) and in liquid maintenance and preservation solutions as gel formulations (HTS Gel & HTS FRS Gel).

FIG. 4 graphically depicts post-storage recovery of MDCK cells stored in suspension in culture plates at 4° C. for 3 days in liquid maintenance and preservation solutions (controls) (media, HTS, & HTS FRS) and in liquid maintenance and preservation solutions as gel formulations (HTS Gel & HTS FRS Gel).

FIG. 5 graphically depicts post-storage recovery of human pancreatic Islets of Langerhans micro-organs stored in suspension in culture plates at 22° C. for 1 day in maintenance and preservation solutions as gel formulations.

FIG. 6 graphically depicts post-storage recovery of human pancreatic Islets of Langerhans micro-organs stored in suspension in culture plates at 22° C. for 3 days in maintenance and preservation solutions as gel formulations.

FIG. 7 graphically depicts post-storage recovery of human pancreatic Islets of Langerhans micro-organs stored in suspension in culture plates at 8° C. for 1 day in maintenance and preservation solutions as gel formulations.

FIG. 8 graphically depicts post-storage recovery of human pancreatic Islets of Langerhans stored in suspension in culture plates at 8° C. for 3 days in maintenance and preservation solutions as gel formulations.

FIG. 9 shows post-storage function of human islets stored for 3 days at 22° C.

### DETAILED DESCRIPTION OF THE INVENTION

The present invention preserves cells in the gel-state (semi-solid matrix). Gel-state preservation offers a number of advantages over liquidous preservation where samples can be suspended in a liquid which then solidifies, placing the specimen into a semi-solid suspended state for preservation. Gel state preservation provides for a number of additional protective avenues beyond liquidous storage including, but not limited to, physical protection from sheer stress and strain, mechanical damage, specimen settling and clumping. In the area of cryopreservation, gel-state preservation offers the benefit of altering the formation and structure of ice crystals thereby reducing the negative physical effects of sub-freezing specimen storage.

As used herein, the term “gel-state” means establishing a semi-solid matrix state in a solution and in cells, tissue or organs suspended in or perfused with that solution. A “gel-state” is a semi-solid formed from a liquid without the formation of crystals. A gel-state refers more particularly to a solid formed from a liquid without the formation of ice crystals. Gel-state preservation is accomplished by reducing the temperature of a solution below the gel solidification point, a variable temperature point based on specific composition ranging from 37° C. to −196° C., such that the cells, tissue or organs are suspended in or perfused with that solution. That is, “gel-state,” as it is used herein, is when a cell, tissue or organ is encapsulated in a semisolid matrix (i.e., in the hypothermic storage solution).

“Hypothermic storage solution” refers to a solution in which cells, tissues, or organs can be stored at temperatures below physiological temperature. Preferred hypothermic storage solutions are described below.

As used herein, a “composition” can have one or more component elements.

As used herein, the term “inhibit” means to reduce an activity by at least 10%, and preferably more, e.g., 20%, 30%, 40%, 50%, 60%, 70%, 80%, 90% or more, up to and including 100% relative to that activity that is not subject to such inhibition. Thus, an agent that inhibits apoptosis inhibits apoptosis and/or necrosis by at least 10% relative to a sample subject to the same apoptotic stimulus but absent the agent.

As used herein, the term “enhance” means to increase an activity by at least 10%, and preferably more, e.g., 20%, 50%, 75% or even 100% or more (e.g., 2×, 5×, 10×, etc.) relative to that activity that is not subject to such enhancement.

As used herein, an “anti-apoptotic agent” refers to a composition that inhibits apoptosis and/or necrosis triggered by or accompanying gel-state preservation of a cell, tissue or organ. Anti-apoptotic agents fall into two broad classes, those that interact with a polypeptide that participates in an apoptotic pathway (e.g., participation in the cellular generation, propagation or execution of an apoptotic signal) and those that inhibit by other means, for example, frequently by avoiding or countering the effects of oxidative stress that tend to activate the apoptotic program. In the first broad class of agents, which target polypeptide factors, there are two sub-categories: a) agents that inhibit the activity of polypeptides that participate in the pathway, and b) agents that maintain or potentiate the activity of polypeptides whose normal role it is to prevent apoptosis. In one embodiment, the present invention uses an anti-apoptotic agent or composition that only targets one or more polypeptide targets. In another embodiment, the present invention uses an anti-apoptotic agent or composition that only targets other aspects of the apoptotic process, e.g., changes in redox status or potential. In another embodiment, the present invention uses one or more agents or compositions that act upon either of these sites.

As used herein, the term “maintains or potentiates the activity of a polypeptide” refers to compositions or agents that prevent a decrease or cause an increase in a given activity of a given polypeptide. For example, when a polypeptide is active in preventing apoptosis, an agent that maintains or potentiates the activity of that polypeptide prevents a decrease in the anti-apoptotic activity of that polypeptide, thereby preventing or inhibiting apoptosis (i.e., inhibiting apoptosis by at least 10% relative to a sample not treated with that agent and subject to the same apoptotic stimulus).

As used herein, the term “composition that interacts with a polypeptide that participates in an apoptotic pathway” refers to a composition comprising one or more agents that, alone or together, physically interact with a polypeptide target in the apoptotic pathway such that apoptosis is decreased or inhibited. Non-limiting examples of such polypeptides are listed in Table I A and B.

As used herein, the term “polypeptide that participates in an apoptotic pathway” refers to a polypeptide, at least one function of which is to promote or inhibit apoptosis. Thus, one class of such polypeptides includes a polypeptide that acts to promote apoptosis—the inhibition of its function or expression, e.g., a specific protease activity, leads to an inhibition of apoptosis. Another class of such polypeptides includes a polypeptide that acts to inhibit apoptosis—the activation or maintenance of its function or expression, e.g., Bcl-2 activity, also leads to an inhibition of apoptosis.

Hypothermic storage solutions useful for semi-solid or gel-state preservation, known and commercially available in the art, can be readily adapted for use in the methods and compositions of the present invention. These include, but are not limited to, various tissue culture medias, saline solutions, HypoThermosol® solution, Viaspan® solution, CryoStor™ solution, Celsior® solution, HTK® solution, Euro-collins™ solution, Normosol® solution, Cardisol™ solution, Unisol® solution, and Plasmalite® solution.

Gel-Based Preservation Solutions

To reduce and even eliminate damage associated with mechanical factors arising from cell storage and transport, gel-based maintenance and preservation media have been developed to sustain biologics in supporting environments of various viscosity. The gel-based media are rigid or highly viscous at temperatures equal to or lower than 28° C. but liquid at 37° C. Liquid maintenance and preservation media (i.e., Hypothermosol® solution, Viaspan® solution, also called University of Wisconsin solution, EuroCollins™ solution, Cardisol™ solution, Unisol® solutions, tissue culture media, etc.) are converted to a gel of appropriate viscosity necessary to match cell, tissue or organ type with either animal or plant derived gelling agents (1-2% by volume). Suitable combinations of such liquid maintenance and preservation solutions may be used if desired.

A preferred organ preservation solution is Hypothermosol® solution. Hypothermosol® solution is composed of (a) one or more electrolytes selected from the group consisting of potassium ions at a concentration ranging from about 10-145 mM, sodium ions ranging from about 10-120 mM, magnesium ions ranging from about 0.1-10 mM, and calcium ions ranging from about 0.01-1.0 mM, (b) a macromolecular oncotic agent having a size sufficiently large to limit escape from the circulation system and effective to maintain oncotic pressure equivalent to that of blood plasma and selected from the group consisting of human serum albumin, polysaccharide and colloidal starch, (c) a biological pH buffer effective under physiological and hypothermic conditions, (d) a nutritive effective amount of at least one simple sugar, (e) an impermeant and hydroxyl radical scavenging effective amount of mannitol, (f) an impermeant anion impermeable to cell membranes and effective to counteract cell swelling during cold exposure, the impermeant ion being at least one member selected from the group consisting of lactobionate, gluconate, citrate and glycerophosphate-like compounds, (g) a substrate effective for the regeneration of ATP, the substrate being at least one member selected from the group consisting of adenosine, fructose, ribose and adenine, and (h) at least one agent which regulates cellular levels of free radicals.

Adjusting the formulation of 1) the carrier medium, in particular, a cell maintenance and preservation solution, 2) gel-type and 3) gel concentration produces an appropriate long-term (up to two weeks) shipping environment, which is commercially known as GELSTOR® solution (Biolife Solutions, Inc., Owego, N.Y., USA). Procedurally, a biologic of choice is exposed to liquefied gel at 37° C., and thereafter cooled to a desired preservation temperature for maintenance and shipment. Upon arrival or point-of-use, the gel is warmed to 37° C. whereupon it liquefies, and may be decanted. The biologic may then be rinsed with an appropriate medium and is ready for use.

The gel-based preservation and maintenance technology disclosed herein provides a semi-solid preservation matrix that facilitates protection of various cells from mechanical stresses associated with biologic preservation and transport. In addition to physical protection, gel-based preservation media provide physiological and biochemical protection during the storage and transport of cells, organs and tissues.

A variety of animal and plant cells may be stored and transported in gel-based media, including human cells and animals cells from numerous tissue sources, including, but not limited to, tumor cells, cells from the liver, kidney or central nervous system, epidermal keratinocytes, endothelial cells, stem cells, white blood cells, fibroblasts, pancreatic islet cells, cardiac and skeletal muscle cells, sperm, egg, and satellite cells. Fetal, neonatal, juvenile and adult cells, tissues and organs all benefit from the protective aspects of the inventive gel-based carrier media. In particular, cells from younger sources are highly sensitive to the mechanical stresses of preservation and transport, and thus are ideal candidates for the mechanically protective aspects of a gel-based preservation medium. Conversely, cells from older sources are highly susceptible to damage from oxidative stresses incurred during preservation and transport, meaning these cells particularly benefit from the physiological and biochemical protection afforded by gel-based preservation media.

Cell lines and tissues from which cell lines are to be developed are suitable for storage and/or preservation in gel-based media. Likewise, organs and tissues from donor animals destined for transplantation into other animals, including humans, have greater viability upon storage and transport in gel-based media. Plant cells and tissues, such as those from transformed or transgenic sources may be stored and/or transported in gel-based media. Likewise, tissue grafts of plants are suitable samples for preservation and, if desired, transport in a gel-based medium. Microbial and fungal cells would also benefit from storage and transport in a gel-based preservation medium. For example, microbial systems used in environmental remediation, such as bacterially-mediated oil degradation or sewage treatment, may be successfully transported to a point of use in a gel-based preservation medium.

Traditionally, preservation and transport of single cells has relied on suspension of cells in a liquid-based medium. Such liquid-based preservation regimes result in the settling of cells to the bottom of the preservation container. This settling causes an inhomogeneous distribution of the cells in the medium resulting in inefficient exposure of the cells to the preservation solution, as well as the exposure of the cells to mechanical stresses of “jarring and shearing” experienced during shipment.

In contrast, gelled preservation solutions permit maintenance of cells in suspension during periods of preservation. This maintenance of cellular suspension eliminates cell sedimentation and reduces mechanical stresses experienced by the cells subjected to storage and/or transport conditions. Additionally, the composition of the gelled preservation medium of the present invention is designed to provide a biochemical environment beneficial to cellular preservation. This protective environment is facilitated through the incorporation of an organ preservation solution as the principal diluent in which the gellation component of the medium is mixed.

Cellular monolayers are sheets of cells one to a few cell layers thick that are grown on an inert matrix in vitro. In the prior art, these monolayers are typically preserved in liquid based preservation media. Due to preservation in liquid-based media, monolayer separation from the growth matrix occurs during preservation. This separation results in the dissembling of the system and ultimately failure caused by the preservation process. Preservation of cellular monolayers using the gelled mediums of the present invention prevents cell-matrix separation during the preservation interval. Additionally, gelled media provide the same preservation benefits to cellular monolayers as is conferred upon cellular suspensions.

Biologic tissues are multi-layered cellular constructs that interact to perform a particular function. The complexity of tissues ranges from engineered tissue constructs including a single cell type (i.e. Epiderm™, MatTech, Ashland, Mass., USA) to human skin grafts, to “micro-organs” (i.e. pancreatic islets), to whole human organs (i.e. kidneys, livers, etc.). In the prior art, preservation of these cell systems, as with single cells and monolayers, is typically performed utilizing liquid preservation media. Due to the complex nature of tissues, the shortcomings of liquid-based preservation technologies include those associated with cell and monolayer preservation, along with the inability to maintain the more intricate cell to cell interactions that are stressed during periods of preservation.

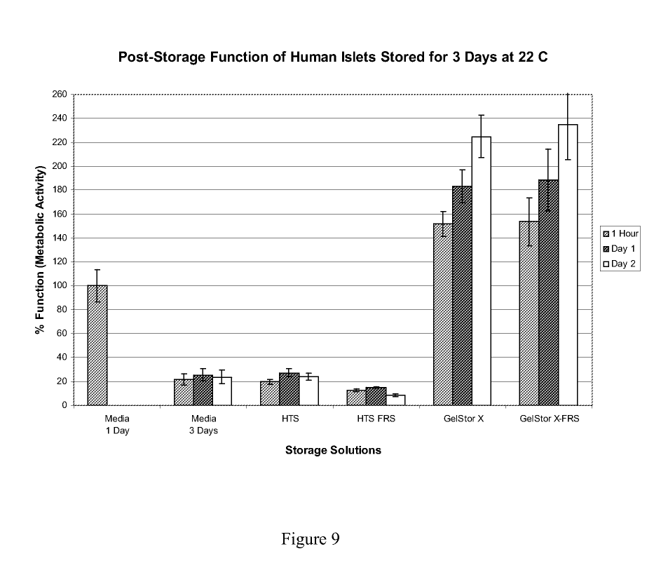

The gelled preservation media of the present invention enable preservation of tissue in a semi-solid preservation matrix, keeping the tissue structurally intact while affording the same protective benefits to the tissue as is conferred to individual cells and cell monolayers. Specifically, the reduction in the external mechanical shipping forces experienced by the tissues shipped in the inventive gel medium markedly improves tissue viability following preservation. For example, pancreatic islet cells preserved in a medium comprising gelatin and Hypothermosol® were afforded significant improvement of islet integrity and functionality following preservation (see FIG. 9).

Types of gellation material suitable for use in a gelled cell preservation medium include, but are not limited to, gelatin, carrageenan, agarose, collagen, laminin, fibronectin, plant-based gelling agents, and combinations thereof. Plant-based gelling agents include gels produced from the roots, stems, tubers, fruit and seeds of plants.

The invention is further described in the following non-limiting examples.

### EXAMPLES

### Example 1

Gel-Based Medium Preparation

Calculations are first performed to determine the necessary volume of gel-based medium for a given storage or transport need. The desired gel concentration must be established. Typically, a standard concentration of 2% is used, although this concentration may vary depending upon the characteristics of the biologic being preserved. A stock solution of gel-based medium was then prepared (standard=14%) in a sterile environment. The volume of stock solution needed was determined and the mass of the appropriate amount of gelatin powder (Sigma Chemicals, St. Louis, Mo., USA) was ascertained. The appropriate volume of organ preservation solution (Hypothermosol®, or “HTS”) was measured and combined via agitation with the gelatin powder. In this instance, the stock solution was mixed by swirling the container having the HTS and gelatin, although any suitable means of agitation may be employed. The stock solution of gel-based medium was then warmed in a 40° C. water bath for 15-20 min with repeated swirling solution (once per minute) to dissolve the gelatin. A 2% solution of gel-based medium was then prepared from this stock solution. The desired volume depended upon the quantity of cells to be preserved. For example, for 100 ml of the 2% solution of gel-based medium, 14 ml of 14% stock solution of gel-based medium was combined with 86 ml of an HTS-Free Radical Scavenger (FRS) solution. The FRS solutions discussed herein and shown in the figures include the anti-oxidant Trolox (vitamin E analogue) which is an anti-apoptotic agent. Aliquots of this 2% solution of gel-based medium were dispensed into 15 ml centrifuge tubes at 10 ml per tube, which were stored at 4° C. until used.

### Example 2

Gel-Based Medium Storage Protocol

Aliquots of previously prepared 2% gel-based medium were removed from 4° C. storage and placed into a 37° C. water bath for 15 minutes to melt the gelatin. While the gel-based medium was warming, samples destined for preservation were prepared in a sterile environment. The desired number of cells to be preserved was transferred into a clean centrifuge tube and was gently centrifuged to pellet cells. Typically, centrifugation at 500×g for 6 min is sufficient to generate a cell pellet from which a supernatant can be decanted. Pelleted cells were then suspended in 0.5-1.0 ml of HTS-FRS solution without gelatin, which is an appropriate volume for preservation in 2% gel-based HTS-FRS medium. The warmed 2% gel-based medium, now in solution form, was removed from the water bath and the suspended cells were pipetted into the warmed medium in a sterile cell culture environment. After tightly securing lids onto the sample storage tubes, the tubes were immediately placed into an ice-water bath for 5 minutes to allow for rapid solidification of the gel-based medium solution. A 2% gel-based medium solution will solidify around room temperature in approximately 30 min, and chilling was used to accelerate the solidification. Chilled sample tubes were then transferred to a desired storage temperature.

Samples prepared in this manner may be stored for any desired time period at appropriate temperatures. For example, cells may be stored for less than 24 hours or for as long as about three days. In one embodiment, storage temperatures preferably range from about −196° C. to about +30° C.

Temperatures are considered “normothermic” in a range between 31° C.-37° C. Temperatures are considered “hypothermic” in a range between 0° C. and 30° C. Cryopreservation generally occurs at temperature below 0° C., and may be achieved using a combination of a gel-based media with cryopreservants.

Sample tubes are removed from storage when the cells contained therein are to be used. Accordingly, the sample tubes in this instance were placed in a 37° C. water bath for 6-8 minutes to melt the gelled medium. However, the gelling agent can be formulated into a preservation medium such that melting can occur at any desired temperature above or below 37° C. While samples were thawing, tubes were inverted every 30 seconds to maintain uniform temperature throughout the samples. Once the gelled medium containing sample cells melted, samples were immediately removed from the water bath. Cell samples were then gently centrifuged to form pellets, typically at 37° C. at 500×g for 6 min. Cell sensitivity to heat stress will delimit tolerable temperature ranges for gel melting for a given biologic. Centrifugation can be performed at room temperature, but the gel-based medium solution may partially resolidify at this temperature. Resolidification causes uncontrolled gel concentration within the cell pellet during centrifugation. For this reason centrifugation at temperatures between 30° C.-37° C. is preferred.

After centrifugation, the gel-based medium supernatant was decanted from the cell pellet, which was then suspended in 12 ml of an appropriate cell culture medium at 37° C. to wash residual gel solution from the cells. The samples were then gently centrifuged to pellet cells at 37° C., typically at 500×g for 6 min. The supernatant was decanted from the pelleted cells prior to resuspension to a desired cell density in an appropriate volume of cell culture media at 37° C. Suspended cells were then transferred to cell culturing vessels at the density desired for growth.

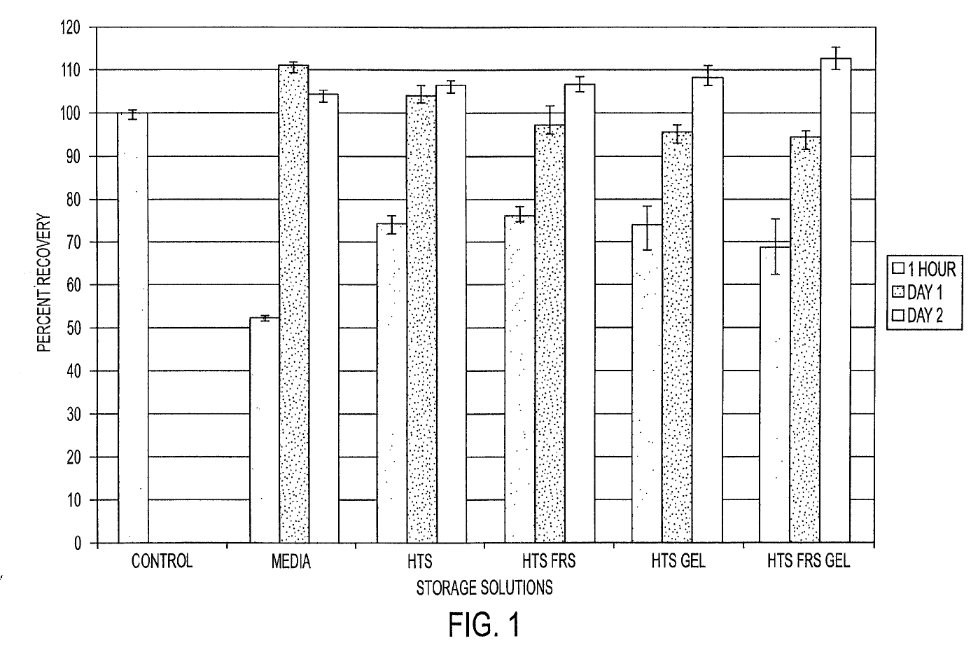

FIG. 1 shows post-storage recovery of MDCK (Madin Darby Canine Kidney) cells stored as monolayers in culture plates at 4° C. for 24 hours in liquid maintenance and preservation solutions (controls) (media, HTS, & HTS FRS) and in liquid maintenance and preservation solutions as gel formulations (HTS Gel & HTS FRS Gel). More specifically, FIG. 1 shows post-storage recovery at 1 hour, 1 day and 2 days after the cells have been removed from the 4° C. storage conditions.

The data in FIG. 1 shows the relative survival of MDCK cells following cold storage in either liquid (media (RPMI culture media), HypoThermosol (HTS), HypoThermosol-FRS (HTS-FRS) or gel-state preservation (HTS-gel; HTS-FRS gel) compared to pre-preservation cultured cells (control). System viability was determined based on the metabolic function of each sample. The data show that MDCK survival following 24 hours of gel-state preservation is equivalent to that of liquid storage demonstrating that gel-state storage is a viable and effective preservation modality. The reduced viability at 1 hour post-storage is due to the depression of metabolism in the system following storage for which a recovery interval is necessary to resume proper function. This recovery period is what is responsible for the differential between the 1 hour and 24 hour data points. Of note, the lower the redound differential (the least change from 1 hour to day 1), the better preserved (less stressed) the cell system.

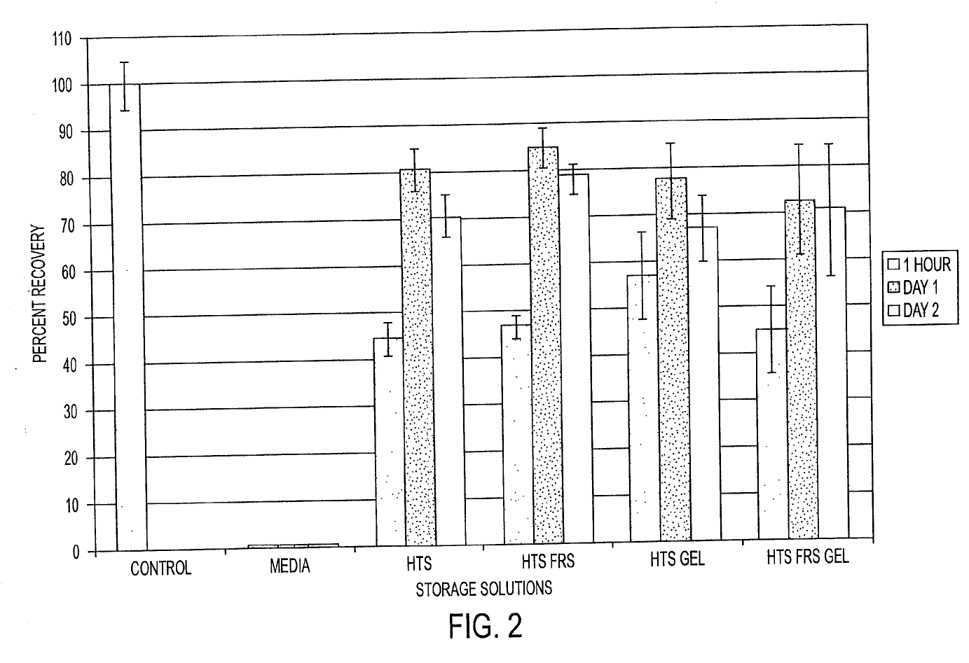

FIG. 2 shows post-storage recovery of MDCK cells stored as monolayers in culture plates at 4° C. for 3 days in liquid maintenance and preservation solutions (controls) (media, HTS, & HTS FRS) and in liquid maintenance and preservation solutions as gel formulations (HTS Gel & HTS FRS Gel). More specifically, FIG. 2 shows post-storage recovery at 1 hour, 1 day and 2 days after the cells have been removed from the 4° C. storage conditions.

The data in FIG. 2 shows the relative survival of MDCK cells following cold storage in either liquid or gel-state preservation compared to pre-preservation cultured cells (control). System viability was determined based on metabolic function of each sample. Overall, the data show that MDCK survival following 3 days of gel-state preservation is equivalent to that of liquid storage demonstrating that gel-state storage is a viable and effective preservation modality. The reduction of viability at 1 hour post-storage is due to the depression of metabolism in the system following storage for which a recovery interval is necessary to resume proper function. This recovery period is what is responsible for the differential between the 1 hour and 24 hour data points. Of note, the lower the redound differential (least change from 1 hour to day 1) the better preserved (less stressed) the cell system.

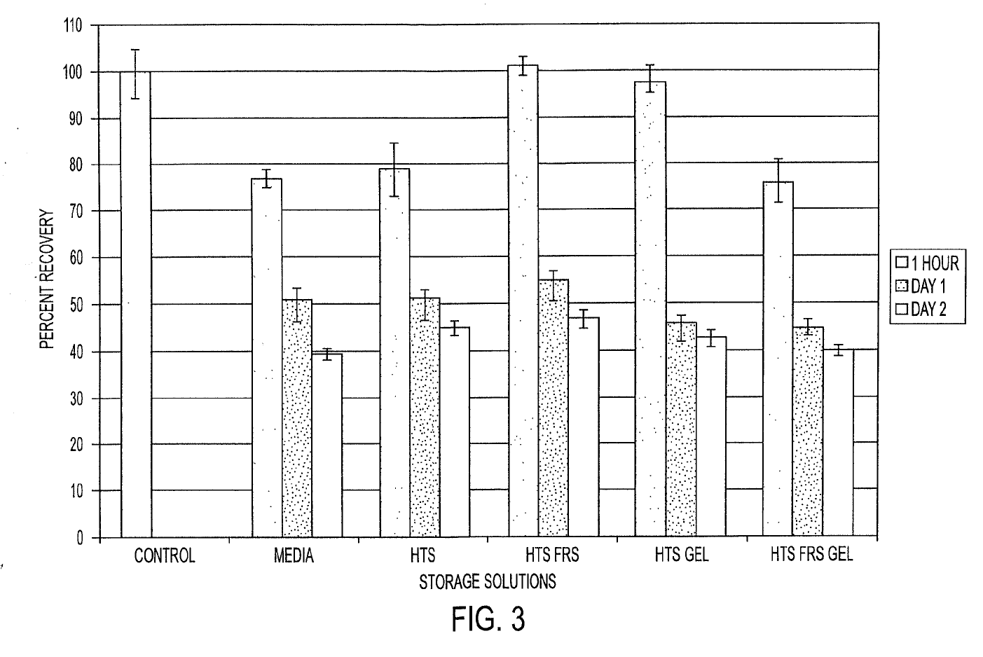

FIG. 3 shows post-storage recovery of MDCK cells stored in suspension in culture plates at 4° C. for 24 hours in liquid maintenance and preservation solutions (controls) (media, HTS, & HTS FRS) and in liquid maintenance and preservation solutions as gel formulations (HTS Gel & HTS FRS Gel). More specifically, FIG. 3 shows post-storage recovery at 1 hour, 1 day and 2 days after the cells have been removed from the 4° C. storage conditions. The use of media only (media, hour data) and HTS (hour data) resulted in a significant loss in cell viability. In contrast, the use of HTSgel (hour data) resulted in a maintenance of cell survival post-storage similar to controls.

The data in FIG. 3 demonstrates that gel-state preservation is more effective in that cell systems can be more optimally preserved under similar conditions (see 1 hour data HTS vs. HTS-gel). Interestingly, this increased protection is cell type and formulary specific as a result of the variance in cell death responses (apoptotic and necrotic) activated during and following gel state-preservation (compare 1 hour HTS GEL vs. HTS FRS Gel).

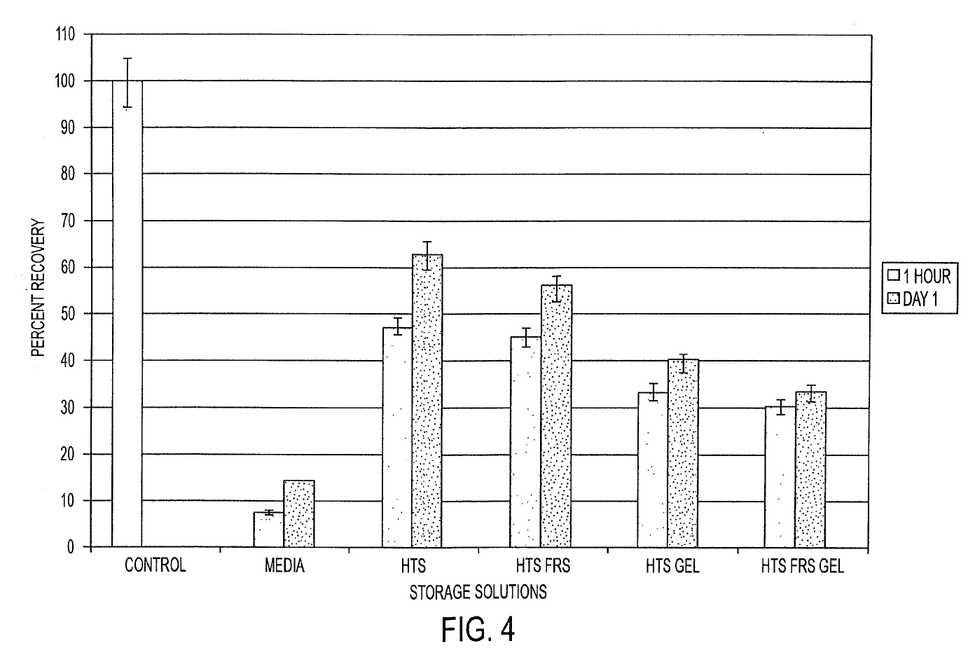

FIG. 4 shows post-storage recovery of MDCK cells stored in suspension in culture plates at 4° C. for 3 days in liquid maintenance and preservation solutions (controls) (media, HTS, & HTS FRS) and in liquid maintenance and preservation solutions as gel formulations (HTS Gel & HTS FRS Gel). More specifically, FIG. 4 shows post-storage recovery at 1 hour and 1 day after the cells have been removed from the 4° C. storage conditions.

The data in FIG. 4 shows the relative survival of MDCK cells following cold storage in either liquid (media (RPMI culture media), HypoThermosol (HTS), HypoThermosol-FRS (HTS-FRS), or gel-state preservation (HTS-gel; HTS-FRS gel) compared to pre-preservation cultured cells (control). System viability was determined based on the metabolic function of each sample. The data from this series of studies demonstrates the advantage of gel state preservation in reducing the time dependent variability in samples during the recovery period. While overall sample viability is important, consistency during the recovery period following extended storage (such as 3 days) is also critical in cell suspension samples.

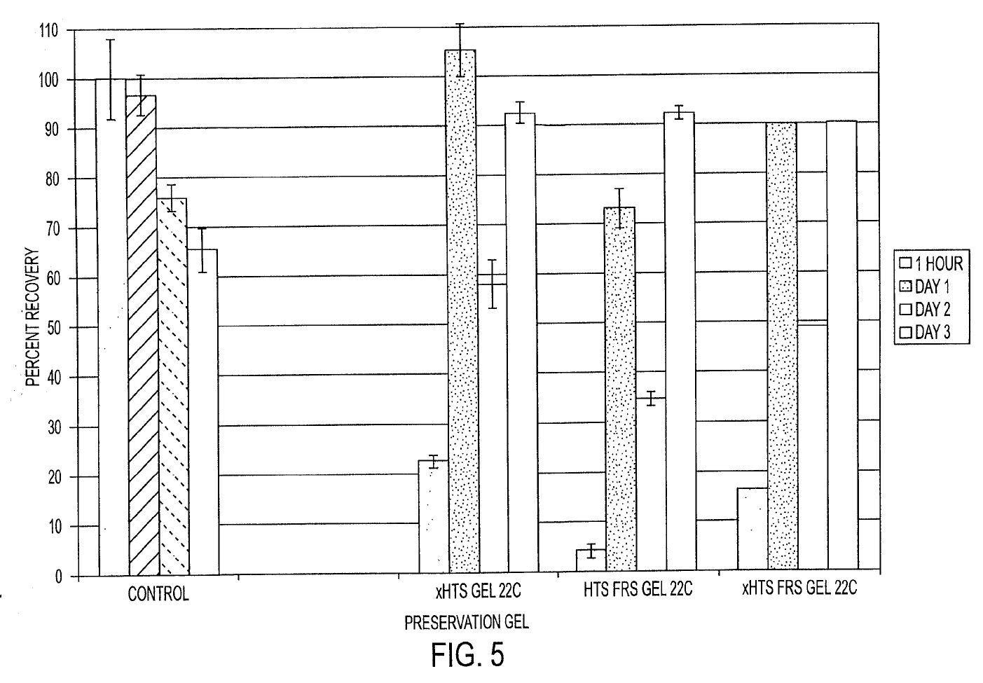

FIG. 5 graphically depicts post-storage recovery of human pancreatic Islets of Langerhans micro-organs stored in suspension in culture plates at 22° C. for 1 day in maintenance and preservation solutions as gel formulations. More specifically, FIG. 5 shows post-storage recovery at 1 hour, 1 day, 2 days and 3 days after the cells have been removed from the 22° C. storage conditions.

The data in FIG. 5 demonstrates the relative survival of islets following gel-state preservation at room temperature—a thermal range not possible for storage under other preservation regimes. Islets were stored in three gel-based preservation media and compared to non-preserved cultured controls. The data show that following the initial recovery period of the islet systems, the gel state preservation regime was highly effective in maintaining islet viability (1 day and 3 day data). The dip in metabolic activity seen at 2 days post storage in all the stored samples was due to the metabolic cycling within the islet samples as the various cell populations within the islets began to re-synchronize following the preservation process. Each of the gel-preservation media differed in their composition on the level of ionic, antioxidant, energy substrate, anti-apoptotic agent, impermanent, etc agent concentrations. For example, the xHTS-gel solution and the xHTS-FRS-gel solution shown in this figure differ in that the xHTS-FRS-gel solution includes the antioxidant Trolox; the two solutions are otherwise identical. The HTS-gel solution shown in this figure is composed of approximately two times the concentrations of each of its components than the xHTS-gel solution. As such, the data also demonstrate the effectiveness of gel-state preservation over a wide array of base preservation media compositions.

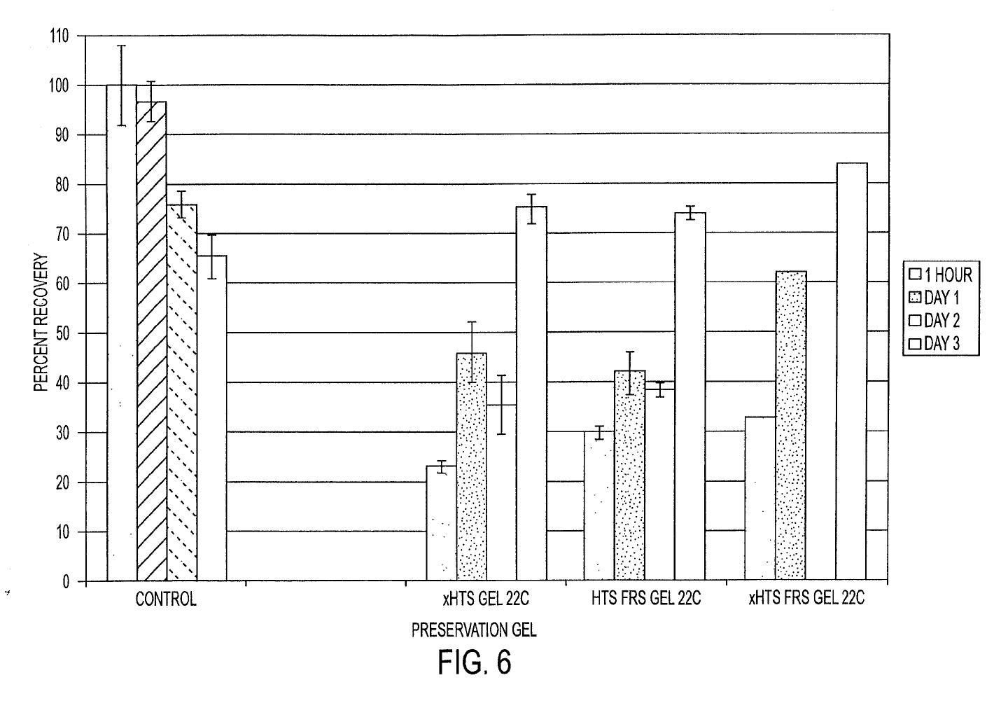

FIG. 6 shows post-storage recovery of human pancreatic Islets of Langerhans micro-organs stored in suspension in culture plates at 22° C. for 3 days in maintenance and preservation solutions as gel formulations. More specifically, FIG. 6 shows post-storage recovery at 1 hour, 1 day, 2 days and 3 days after the cells have been removed from the 22° C. storage conditions.

The data in FIG. 6 demonstrates the relative survival of islets following gel-state preservation at room temperature for 3 days—a thermal range not possible for storage under other preservation regimes. Islets were stored in three gel-based preservation media and compared to non-preserved cultured controls. The data show that following the initial recovery period of the islet systems, the gel state preservation regime was highly effective in maintaining islet viability (1 day and 3 day data). In contrast to FIG. 5, no dip in metabolic activity is seen at 2 days post storage. This is due to the synchronization event of the islets occurring during the extended cold storage interval. Each of the gel-preservation media differed in their composition on the level of ionic, antioxidant, energy substrate, anti-apoptotic agent, impermanent, etc agent concentrations. As such, the data also demonstrate the effectiveness of gel-state preservation over a wide array of base preservation media compositions.

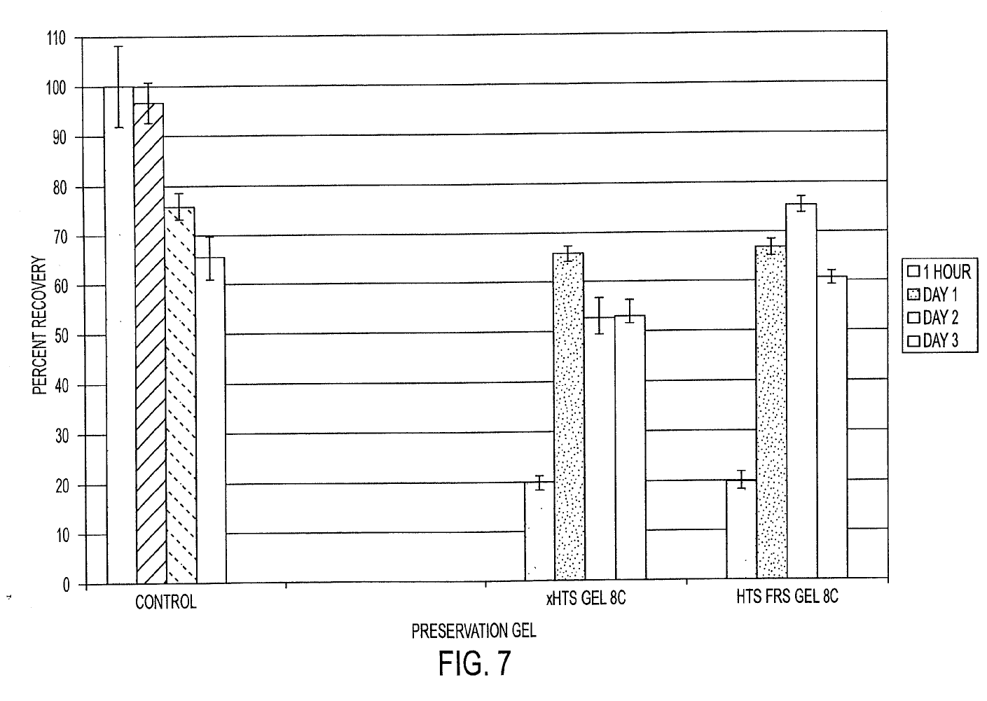

FIG. 7 shows post-storage recovery of human pancreatic Islets of Langerhans micro-organs stored in suspension in culture plates at 8° C. for 1 day in maintenance and preservation solutions as gel formulations. More specifically, FIG. 7 shows post-storage recovery at 1 hour, 1 day, 2 days and 3 days after the cells have been removed from the 8° C. storage conditions.

The data in FIG. 7 demonstrates the relative survival of islets following gel-state preservation at hypothermic temperatures for 1 day. Islets were stored in two low temperature gel-based preservation media and compared to non-preserved cultured controls. The data show that following the initial recovery period of the islet systems, the gel state preservation regime was highly effective in maintaining islet viability (1 day, 2 day, 3 day data). Each of the gel-preservation media differed in their composition on the level of ionic, antioxidant, energy substrate, anti-apoptotic agent, impermanent, etc agent concentrations. As such, the data also demonstrate the effectiveness of gel-state preservation over a wide array of base preservation media compositions.

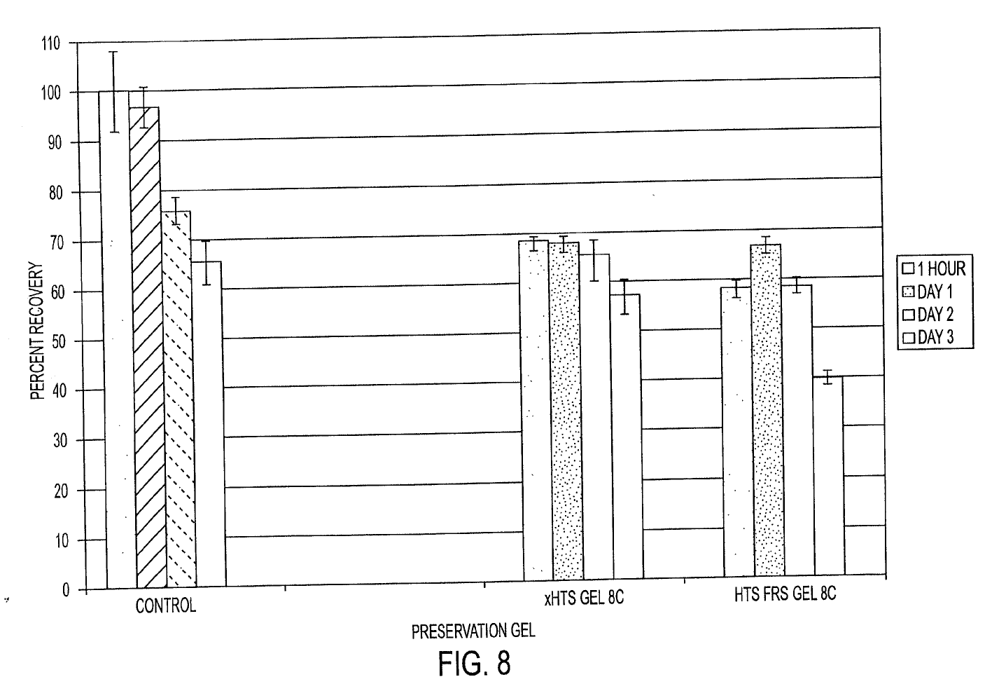

FIG. 8 shows post-storage recovery of human pancreatic Islets of Langerhans stored in suspension in culture plates at 8° C. for 3 days in maintenance and preservation solutions as gel formulations. More specifically, FIG. 8 shows post-storage recovery at 1 hour, 1 day, 2 days and 3 days after the cells have been removed from the 8° C. storage conditions.

The data in FIG. 8 demonstrates the relative survival of islets following gel-state preservation at hypothermic temperatures for 3 days. Islets were stored in two low temperature gel-based preservation media and compared to non-preserved cultured controls. The data show that following the initial recovery period of the islet systems, the gel state preservation regime was highly effective in maintaining islet viability (1 day, 2 day and 3 day data). Each of the gel-preservation media differed in their composition on the level of ionic, antioxidant, energy substrate, anti-apoptotic agent, impermanent, etc agent concentrations. As such, the data also demonstrate the effectiveness of gel-state preservation over a wide array of base preservation media compositions. Further, these data demonstrate that by storing islets in the cold in gel-state preservation one can maintain islet survival both in the cold and in culture for extended periods (3 days in the cold) and have minimal effect on long term survival (3 days culture) where as simple culture of the islets for 3 days results in a substantial decline in sample viability (decrease in viability in controls over three days).

Referring now to FIG. 9, a direct comparison of a media based approach, a HTS based approach and the approach of the present invention utilizing a Human Islet model for storage at 22° C. reveals that both the media and HTS based approaches fail to protect the islets to any degree. In contrast, the gel-based media facilitates substantial protection of the islets during storage, thereby resulting in increased viability post-storage.

The data in FIG. 9 demonstrates the comparison between islet survival following storage at 22° C. for 3 days in liquid or gel-state preservation. The data are compared to typical islet survival following liquid storage in culture media (RPMI) for 1 day at 22° C. (industry standard shipment regime). The data show that gel-state preservation and the control of molecular based cell death (using anti-apopotic agents, such as the ant-oxidant Trolox found in the Gelstor X-FRS) results in a significant improvement in cell survival compared to both short-term (Media 1 day) and long-term (media 3 day, HTS, and HTS-FRS) liquid storage. Specifically, in the case of islets, this improvement in metabolic activity (islet function) was seen to be an 80% overall improvement at day 1 following 3 days of gel storage compared to 1 day liquid storage. This represents a significant advancement in preservation efficacy for islets going from one day to 3 days while providing for greater cell viability and function.

Gel-Based Preservation Solutions Including One or More Apoptotic Agents

The present invention also includes a method of preserving a eukaryotic cell, tissue or organ by contacting the cell, tissue or organ with a hypothermic storage solution containing an agent that inhibits apoptotic cell death and a gelling agent, and storing the cell, tissue or organ and the hypothermic storage solution surrounding or perfusing the cell, tissue or organ. The gel-state preservation is accomplished through use of a hypothermic storage solution that has a gelling agent. Reduction of the temperature of a sample in such a solution to below the gelling temperature results in the gel-state encapsulation of the cell, tissue or organ in that solution. The inclusion of one or more anti-apoptotic agents aids in preventing the apoptotic cell death that normally occurs subsequent to this type of preservation.

Gel State Preservation:

Gel-state preservation according to the invention involves the use of a hypothermic storage solution that forms a semi-solid matrix (gel), rather than a liquid or crystalline solid when exposed to low temperatures, specifically, temperatures below the gelling point of the solution. Gel-state preservation as the term is used herein involves the non-crystalline liquid to semi-solid phase transition of the surrounding or perfused hypothermic storage solution thereby encapsulating the cell, tissue, or organ. This gel-state thus does not involve the formation of macromolecular crystals (such as ice crystals) within or outside of cells, tissues or organs placed into or perfused with such a solution. This is in contrast to cryopreservation, in which ice crystals are permitted to form outside of such cells, or hypothermic storage where cells are bathed in a liquid media for the preservation interval.

In one embodiment, gel-state preservation involves the steps of contacting the cells, tissue or organ with the hypothermic storage solution that contains one or more agents that inhibit apoptosis, and then reducing the temperature below the gelling point (solidification point) of the solution, such that a gel-like semi-solid is formed. The rate of cooling depends upon the solution, but is generally in the range of 0.5° C. to 50° C. per minute, most often approximately 1° C. to 20° C. per minute, e.g., approximately 1° C. per minute, approximately 5° C. per minute, approximately 10° C. per minute, approximately 15° C. per minute or approximately 20° C. per minute. The skilled artisan can identify an optimal rate of cooling for a given combination of the gel-state solution and tissue.

Gel-state formation may be monitored in several ways. One of the simplest ways is to observe the solution (solid vs. liquid above 0° C.) or by observing or measuring the transmission of light through the gel.

The gel-state sample is then stored below the gelling point. The gelling point generally ranges from +25° C. to −196° C. (liquid nitrogen temperature). Further reduction in temperature below the gelling point is often desirable. Such preservation maintains the semi-solid state of the gel without permitting melting or crystallization within and outside of cells.

The step of contacting cells, tissues or organs with a hypothermic storage solution differs depending upon whether the sample is cells, a tissue or an organ. For example, cells or relatively thin (e.g., up to about 2-5 mm) or porous tissues (e.g., skin or artificial skin) can simply be immersed in the hypothermic storage solution prior to chilling to cause gelling. This immersion is preferably performed at or near 22° C. or 4° C. The length of time necessary for immersion will clearly vary with the thickness of the tissue, with longer times necessary as the tissue becomes thicker. One of skill in the art can readily evaluate and adjust the time necessary for the immersion of a given sample or type of sample by evaluating the survival, recovery and degree of apoptosis occurring in samples immersed for varying lengths of time before the initiation of gelling.

For organs, e.g., kidney, liver, heart, lung, etc., it may be necessary to perfuse the organ with the hypothermic storage solution. Methods for organ perfusion vary for different organs but are well known in the art. For perfusion of organs, an important parameter is the viscosity of the solution. More porous organ tissues (e.g., liver) may be perfused with relatively higher viscosity solutions than can less porous tissues (e.g., heart). Because of differences in the ability to perfuse different tissues, it may be necessary in some cases to perfuse with an increasing gradient, or with stepwise increases, of the concentration of hypothermic storage solution until a concentration is achieved such that the tissue will gel throughout upon subsequent reduction of temperature.

Apoptosis and Anti-Apoptotic Agents:

The precise cellular mechanisms regulating apoptosis are not completely known. However, various aspects of the apoptotic pathway have been elucidated. For example, alteration of the ionic environment may be necessary to activate or inhibit the endonucleases relevant to the process of apoptotic nuclear degradation (e.g., physiologic concentrations of Zn++ are known to inhibit DNA fragmentation and apoptosis). Treatment of certain cells with inhibitors of macromolecular synthesis, such as Actinomycin D to block RNA synthesis or cyclohexamide to block protein synthesis, induces apoptosis. Completion of the apoptotic process appears to depend upon the regulated expression of various gene products associated with the promotion or suppression of gene activated cell death, particularly gene products involved with cell cycle regulation. For example, overexpression of the cell-death inhibiting agents Bcl-2 and Bcl-xL prevents the release of cytochrome C. Cytochrome C is thought to activate the caspases, a group of proteases known for cleaving substrates responsible for the changes associated with apoptosis. Enhanced levels of Bax, a pro-apoptotic member of the Bcl-2 family, promote cytochrome C release and subsequent apoptosis of cells. Specific regulation of the early response genes c-myc, c-jun and c-fos may promote either cell growth or cell death, depending upon the circumstances surrounding their expression. Another trigger for apoptosis involves oxidative stress. In this regard, antioxidants and free-radical scavengers have been demonstrated to inhibit the initiation of apoptosis. Thus, programmed cell death involves an intricate cascade of cellular events.

The inventors of the present invention have determined that hypothermic storage is among the numerous triggers for apoptosis. In particular, the gel-state preservation of cells tends to cause a portion of the cells to undergo apoptosis and/or necrosis when they are removed from gel-state storage. While it is not known exactly what molecular mechanism is the triggering event for gel preservation-induced apoptosis, the inclusion, in the hypothermic storage solution used for gel-state preservation, of one or more agents that alone or collectively inhibit apoptosis can increase the survival and recovery of the cells.

There are a number of agents known to inhibit apoptosis. Agents useful according to the invention can function at any stage of the apoptotic pathway, e.g., by modulating the function or expression of one or more nuclear or cytoplasmic polypeptide mediators of the pathway (e.g., gene products in the regulatory cascade such as Bcl-xL, Bcl-2 or Bax, cytochrome C, caspase enzymes, etc.) or by avoiding or countering the effects of oxidative stress known to trigger apoptosis (e.g., through use of antioxidants, free radical scavengers or agents that modulate the function or expression of nitrous oxide synthase).

One useful way to categorize inhibitors of apoptosis is to consider those that interact with a cellular polypeptide factor that participates in the generation, propagation or execution of an apoptotic signal to be one category, and those that inhibit by other means as a second category. In the first category, the interaction of the agent with the polypeptide factor is a physical, i.e., binding, interaction. For example, an agent that physically interacts with and inhibits the function of a caspase enzyme would fall into this category. In the second category the agent need not necessarily interact with or bind a polypeptide, but rather acts by, for example scavenging free radicals or maintaining the redox status quo. Examples of agents in the second category include, for example, Vitamin E and other agents listed in Table II.

According to an embodiment of the present invention, a composition that inhibits apoptosis includes at least one agent that reduces the extent of apoptotic cell death, but may include, for example, two or more such agents, where each such agent preferably, but not necessarily, interacts with a different part of an apoptotic pathway. In another embodiment, the composition includes two or more agents that together have an inhibitory effect on apoptosis that neither has on its own, or that together have a synergistic effect.

An anti-apoptotic agent useful according to the invention will inhibit apoptosis, as measured by a TUNEL assay, by at least 10% relative to a sample subjected to the same apoptotic induction conditions without the addition of the anti-apoptotic agent.

Some cellular polypeptide targets involved in the promotion of apoptosis are listed in Table IA. In one embodiment of the present invention, an anti-apoptotic agent useful according to the invention can act on one or more of these cellular polypeptide targets. Table IB also lists exemplary targets involved in the prevention of apoptosis. In another embodiment, an anti-apoptotic agent can act to increase or stabilize the activity of one or more of these cellular polypeptide targets.

As noted, an important class of anti-apoptotic agents is the caspase inhibitors, a number of which are known and commercially available. One class of caspase inhibitors comprises fluoromethylketone (FMK) derivatives of peptides that mimic the recognition and cleavage sites for the target caspase enzymes. Among these are, for example: caspase-1 inhibitor YVAD-FMK (benzyloxycarbonyl tyrosylvalylalanyl aspartic acid fluoromethyl ketone), which irreversibly binds activated caspase 1; caspase-3 inhibitor DEVD-FMK (benzyloxyycarbonyl aspartyl glutamylvalylaspartic acid fluoromethyl ketone), which irreversibly binds activated caspase 3 but also inhibits caspase 7, caspase 10, and caspase 6 in decreasing order of binding affinity; caspase-6 inhibitor VEID-FMK (benzyloxycarbonyl valylglutamyl isoleucylaspartic acid fluoromethyl ketone), which irreversibly binds activated caspase 6 and also inhibits caspases 3, 7, and 8 in decreasing order of binding affinity; caspase-8 inhibitor LETD-FMK (benzyloxycarbonyl leucylglutamylthreonylaspartic acid fluoromethyl ketone), which irreversibly binds activated caspase 8, and also binds caspase 1 and caspase 10 with lower affinity; caspase-9 inhibitor LEHD-FMK (benzyloxycarbonyl leucylglutamylhistidylaspartic acid fluoromethyl ketone), which irreversibly binds caspase 9 and also binds caspases 4, 5 and 6. Additional FMK-peptide derivatives useful for the inhibition of caspases include, but are not limited to caspase-2 inhibitor VDVAD-FMK, caspase-4 inhibitor Z-LEVD-FMK, caspase-5 inhibitor WEHD-FMK, caspase-10 inhibitor AEVD-FMK and caspase-13 inhibitor LEED-FMK. These caspase inhibitors, and cocktail mixtures of them are commercially available from, for example, Gentaur Molecular Products (Brussels, Belgium).

Additional anti-apoptotic agents include the calpain inhibitors (e.g., Calpain Inhibitor Z-LLT-FMK) and the cathepsin B&L inhibitor Z-Phe-Phe-FMK. These inhibitors are also available from Gentaur Molecular Products. Others include Calpain Inhibitor I (N-Acetyl-Leu-Leu-norleucinal, available from Roche Diagnostics), Calpain Inhibitor II (N-Acetyl-Leu-Leu-methioninal, available from Roche Diagnostics), and CTX295 (a dipeptide alpha-ketoamide compound which inhibits calpain (DiBiasi et al., 2001, J. Virol. 351-361)). Additional anti-apoptotic agents useful according to the invention are listed in Table II.

The amount of an anti-apoptotic agent or agents useful in a gel-based storage solution according to the invention will vary depending on the nature of the inhibitor and its target, if the target is known (there is no requirement that the specific target of the apoptotic inhibitor useful according to the invention be known). Generally, the amount of anti-apoptotic agent useful will be that amount or concentration determined by the user to provide at least 10% (and preferably greater) inhibition in apoptosis following removal from the gelled state relative to a sample that was in the gelled state in the absence of the inhibitor or inhibitors. The concentration of anti-apoptotic agent useful according to the invention will further not be associated with significant (i.e., greater than 2% cell death over the course of treatment or contact) toxic effects. The level at which an agent becomes toxic will vary with the agent and will generally be known or readily determined by one of skill in the art.

TABLE I

| | | |
|---|---|---|
| | | Pathway Location |
| | | (Initiation, |
| | | Execution, |
| Target | Definition | Termination) |

A. Cellular Targets Involved in the Promotion of Apoptosis
which can be Inhibited to Improve Gel-State Preservation

| | | |
|---|---|---|
| Caspases | (Cystine Proteases) | Initiation, |
| | | Execution, |
| | | Termination |
| ROCK | | |
| CAD | (Caspase Activated | Termination |
| | DNAse) | |
| ASK1 | | Initiation, |
| | | Execution |
| JNK | (Jun Kinase Family) | Initiation |
| Fas | | Initiation |
| FADD | (Fas Activated Death | Initiation |
| | Domain) | |
| TNF | (Tumor Necrosis | Initiation |
| | Factor) | |
| TRADD | (TNF Receptor Activated | Initiation |
| | Death Domain) | |
| RIP | (receptor Interacting | Initiation |
| | Protein) | |
| DAXX | | Initiation |
| Granzyme B | | Initiation |
| Bad | (Mitochondrial Pro- | Initiation, |
| | apoptotic protein) | Execution |
| Bax | (Mitochondrial Pro- | Initiation, |
| | apoptotic protein) | Execution |
| Bid | | Initiation, |
| | | Execution |
| Cytochrome C | | Initiation, |
| | | Execution |
| AIF | (Apoptosis Initiation | Initiation, |
| | Factor) | Execution |
| MAPK | (Mitogen Activated | Initiation |
| | Protein Kinase Family) | |
| Calpain | (Serine Proteases) | Initiation, |
| | | Execution, |
| | | Termination |
| Caspathin | | Initiation, |
| | | Execution, |
| | | Termination |
| Nitric Oxide | | Initiation |
| PARP | (Poly-ADP Ribose | Termination |
| | Polymerase) | |
| DFF | (DNA Fragmentation | Termination |
| | Factor) | |

B. Cellular Targets Involved in the Prevention of Apoptosis
which can be Activated to Improve Preservation Efficacy

| | | |
|---|---|---|
| Bcl-2 | (Mitochondrial Anti- | Initiation, |
| | apoptotic protein) | Execution |
| Bcl-x | (Mitochondrial Anti- | Initiation, |
| | apoptotic protein) | Execution |
| IAP | (Inhibitor of Apoptosis | Initiation, |
| | Protein) | Execution |
| RAS | Receptor mediated pro- | Initiation |
| | survival signal | |
| AKT | Anti-apoptosis signal | Initiation, |
| | | Execution |
| TRAF2 | (TNF Receptor Associated | Initiation |
| | Factor 2) | |

TABLE II
Free Radical Scavengers and Other Anti-apoptotic Agents

Flavonoids
Vitamin E
Vitamin C
Vitamin D
Beta Carotene (Vitamin A)
Pycnogenol
Super Oxidedismutase
N-Acetyl Cysteine
Selenium
Catechins
Alpha Lipoic Acid
Melatonin
Glutathione
Zinc Chelators
Calcium Chelators
L-Arginine

Measurement of Apoptosis:

There are a number of ways for one to measure the extent of apoptosis occurring following the gel state preservation of a sample containing cells. As noted, one of the hallmarks of apoptosis is a regular DNA fragmentation pattern leading to a “ladder” when genomic DNA is subjected to gel electrophoresis. This assay is well known in the art, and can be performed as described in U.S. Pat. No. 6,045,990.

Another assay useful for more quantitative measurement of apoptosis is the TUNEL assay (Terminal deoxynucleotidyl transferase mediated dUTP nick end labeling). This assay measures the enzymatic incorporation of labeled dUTP at the nick or breaks in DNA that accompany apoptosis. The assay is well known to those of skill in the art, and kits for performing the assay are available, for example, from Intergen (ApopTag™ kit, Intergen Company, Purchase, N.Y.).

Alternatively, one may directly assay caspase activity. Kits for this are also commercially available, e.g., from Promega (Madison, Wis.).

Other assays for apoptosis are also known to those of skill in the art. For example, Annexin V binding to cells can be measured. One of the early events of apoptosis is the loss of membrane asymmetry of phospholipids. Phosphotidylserine, normally located in the inner leaflet of the membrane, redistributes and appears in the outer leaflet at the early stage of apoptosis. Annexin V binds specifically to phosphotidylserine on apoptotic cell surfaces in the presence of calcium, and can be used as a marker for apoptosis. Binding can be measured by monitoring a fluorescent tag on the Annexin V, e.g., fluorescein.

Removal from the Gel State

The process for the removal of cells, tissues or organs from the gel-state state will vary depending upon the cell, tissue or organ preserved. The general process involves warming the sample above the gelling point, followed by rinsing or dilution of the sample to remove the hypothermic storage solution, followed by re-establishment in culture or by implantation into a recipient. Rinsing can be performed by simple sample dilution (e.g. for isolated cells and cell suspensions), immersion (e.g., for cells or relatively thin tissues) or by perfusion (e.g., for organs). While minimizing time out of standard culture conditions or a recipient individual is always desirable, it may be advantageous to remove gel solution by stepwise immersion or perfusion with gradually reduced concentrations of solution agents. In such circumstances, it may be advantageous to include an anti-apoptotic composition in the rinse solution or solutions. In fact, an anti-apoptotic composition can advantageously be added to any such rinse solution.

Measurement of Gel-State Storage Efficiency:

The term “gel-state storage” encompasses storage for a matter of hours or for a matter of weeks, months or years. The level of cell survival acceptable for such storage will depend upon the cell, tissue or organ type stored and the reason for its storage (e.g., transplantation versus research uses), but will advantageously be higher than is practicable using prior art technologies. When a cell, tissue or organ is used for human transplantation, it is advantageous to maximize the survival and ensuing function of the cell, tissue or organ. Generally, however, gel-state storage is considered successful if it is accompanied by death of about 20% or fewer of the cells, preferably 10% or less, and most preferably less than 5%, up to and including full viability and function.

The storage efficacy of numerous cell preservation solutions can be assessed using a number of assays. Such assays include enzyme synthesis (Pahernik et al., 1996, Cryobiology 33: 552), potassium content (Fisher et al., 1996, Cryobiology 33: 163), trypan blue exclusion (Rodriguez et al., 1995, Cell Transplant. 4: 245), neuronal outgrowth and myelination (Levi et al., 1994, Glia 10: 121), contraction (Lopukhin et al., 1996, Cryobiology 33: 178), ATP content (Zhang et al., 1996, J. Surg. Res. 63: 314), and ultrastructure (Carbognani, et al., 1995, J. Cardiovasc. Surg. 36: 93). These assays can be considered either viability or functional assays. Thus, the maltose tolerance test used by Katz et al. (Katz et al., 1995, Transplantation 59: 694) on the small intestine could be considered a functional assay; whereas the trypan blue test used by Rodriguez et al. (Rodriguez et al., 1995, supra) is strictly a viability assay. The references cited in this paragraph are all incorporated herein by references.

A preferred assay for viability uses the alamarBlue® non-toxic dye. The assay using alamarBlue® dye measures viability by the metabolic conversion of the agent to a fluorescent form detectable with standard fluorescence detection equipment. The assay does not indicate whether or not test cells are functioning in a tissue specific manner. However, one of the key attributes of the alamarBlue® dye assay that is not shared by most of the other viability or function assays described previously is the ability of alamarBlue® dye to be used repetitively, day after day, as a non-toxic indicator. This has been shown to be critically important to some cold-stored tissues such as human skin cells.

An example of the conditions for alamarBlue® dye viability testing following gel-state storage is as follows. Cells (e.g., cultured cells or cells isolated from a patient) are washed with isotonic buffer solution (e.g., phosphate buffered saline, Hanks' Balanced Salt Solution (HBSS), etc.) and the medium is replaced with a gel-state storage solution, containing at least one apoptosis inhibiting agent. The cell sample is cooled and maintained for a given time period at low temperature, e.g., 4° C., after which the sample is warmed such that the solution returns to the liquid state. The gel-state storage solution is removed, cells are washed in isotonic buffer solution or cell culture medium and plated for growth in appropriate cell culture medium. After a given period of time (generally about 24 hours, but advantageously later, e.g., 48 hours or more) medium is removed from the recovered cultures, and a 1:20 dilution of alamarBlue® dye (Accumed International, Westlake, Ohio) in HBSS without phenol red is placed on the cells. Fluorescence of the converted dye is measured using, for example, a CytoFluor 2350 (Millipore Corporation, Bedford, Mass.) or a CytoFluor II (PerSeptive Biosystems, Inc., Cambridge, Mass.) apparatus with a 530 nm excitation/590 nm emission filter set. Following the assay, cells can be provided with fresh medium and re-cultured with repeat assays at later times as desired.

Another way to monitor the viability of recovered cells, tissues or organs uses the dye Calcein-AM (Molecular Probes, Eugene, Ore.), which monitors membrane integrity. Calcein-AM is suspended at 1 mg/ml in DMSO and then mixed with HBSS at 1:100. This solution is then contacted with recovered cells for one hour, followed by washing with HBSS. Fluorescence of the retained dye, indicative of dead cells, is then measured using a 485 nm excitation/530 nm emission filter set.

The present invention preserves various organs, tissues and cells using semi-solid gel-state storage. Organs, including but not limited to lung, liver, heart, kidney, gut, eye and skin can be preserved according to the invention prior to transplantation in a recipient patient. Tissues such as bone marrow and cells such as erythrocytes and leukocytes can be preserved for long term storage according to the invention. For example, tissues for forensic and pathology records may be preserved without significant loss of viability. Cell lines for therapeutic and research interests can be preserved for long periods by applying the invention. It is contemplated that variations of the invention can be applied for long term preservation of entire multicellular organisms.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of preserving a eukaryotic cell, tissue or organ comprising:
a) contacting the cell, tissue or organ with a storage solution, wherein the solution comprises:
i) a composition that inhibits apoptosis; and
ii) a concentration of a gelling agent that is sufficient for gel solidification of the solution; and
b) storing the cell, tissue or organ in the solution.

2. The method of claim 1 wherein the storage solution has a gelling temperature below 37° C.

3. The method of claim 1 wherein the gelling agent is selected from the group consisting of:
a) gelatin;
b) carrageenan;
c) agarose;
d) collagen;
e) laminin;
f) fibronectin;
g) a plant based gelling agent; and
h) any combination of a) through g).

4. The method of claim 1 wherein the cell, tissue or organ is stored in the storage solution at a temperature between 30° C. and −196° C.

5. The method of claim 1, wherein the cell, tissue or organ is stored in the storage solution at a temperature between 0° C. and −196° C.

6. The method of claim 1, wherein the cell, tissue or organ is stored below a gelling temperature of the storage solution.

7. The method of claim 1 wherein the composition that inhibits apoptosis comprises an agent that interacts with a polypeptide that participates in an apoptotic pathway.

8. The method of claim 7 wherein the agent inhibits the activity of the polypeptide.

9. The method of claim 7 wherein the agent maintains or potentiates the activity of the polypeptide.

10. The method of claim 7 wherein the agent is selected from the group consisting of a caspase inhibitor, a calpain inhibitor, and an inhibitor of nitrous oxide synthase.

11. The method of claim 1 wherein the composition that inhibits apoptosis comprises an antioxidant.

12. The method of claim 1 wherein the composition that inhibits apoptosis comprises an agent selected from the group consisting of a free radical scavenger, a zinc chelator, and a calcium chelator.

13. The method of claim 1, wherein the storage solution further comprises at least one agent that protects the cells, tissue, or organ from ice-related damage.

14. The method of claim 13, wherein the agent that protects the cells, tissue, or organ from ice-related damage is selected from the group consisting of dimethyl sulfoxide, glycerol, and propanediol.

15. A preservation solution comprising:
a) a composition that inhibits apoptosis, and
b) a gelling composition that comprises a concentration of one or more agents that is sufficient for gel solidification of the solution when the temperature of the solution is reduced below the gelling point of the solution.

16. The solution of claim 15 wherein the gelling point of the solution is higher than the homogeneous nucleation temperature of the solution.

17. The solution of claim 15 wherein the composition that inhibits apoptosis comprises an agent that interacts with a polypeptide that participates in an apoptotic pathway.

18. The solution of claim 17 wherein the agent inhibits the activity of the polypeptide.

19. The solution of claim 17 wherein the agent maintains or potentiates the activity of the polypeptide.

20. The solution of claim 17 wherein the agent is selected from the group consisting of a caspase inhibitor, a calpain inhibitor, and an inhibitor of nitrous oxide synthase.

21. The solution of claim 20, wherein the agent is a caspase inhibitor and is selected from the group consisting of peptide fluoromethyl ketone, CHO, a peptide chloromethyl ketone, DCB, AOM and FAOM.

22. The solution of claim 20 wherein the agent is a calpain inhibitor and is selected from the group consisting of leupeptin, calpain inhibitors I, II, III, IV and V, calpeptin, loxastatin, a peptide chloromethyl ketone and a peptide fluoromethyl ketone.

23. The solution of claim 16 wherein the composition that inhibits apoptosis comprises an antioxidant.

24. The solution of claim 23 wherein the antioxidant is selected from the group consisting of glutathione, N-acetyl cysteine, beta carotene, Vitamins E, D, C and A, Nitric Oxide, L-arginine, and super oxide dismutase.

25. The solution of claim 16, wherein the composition that inhibits apoptosis comprises an agent selected from the group consisting of a free radical scavenger, a zinc chelator, and a calcium chelator.

26. The solution of claim 25, wherein the agent is a free radical scavenger selected from the group consisting of Vitamins E, D, C and A, Nitric oxide, L-arginine and super oxide dismutase.

27. The solution of claim 16, further comprising at least one agent that protects the cells, tissue, or organ from ice-related damage.

28. The solution of claim 27, wherein the agent that protects the cells, tissue, or organ from ice-related damage is selected from the group consisting of dimethyl sulfoxide, glycerol, and propanediol.

29. A method of preserving a eukaryotic cell, tissue or organ comprising:
a) contacting the cell, tissue or organ with a storage solution, wherein the solution comprises:
i) a composition that inhibits apoptosis; and
ii) a concentration of a gelling agent that is sufficient for gel solidification of the solution; and
b) storing the cell, tissue or organ in a gel-state wherein the gel-state occurs in the storage solution comprising and comprised by the cell, tissue or organ thereby encapsulating the cell, tissue, or organ.

30. A gel-based medium composition for transport or storage of cell samples, the composition comprising:
(a) a plurality of electrolytes comprising potassium ions at a concentration ranging from about 10-145 mM, sodium ions at a concentration ranging from about 10-120 mM, and calcium ions at a concentration ranging from about 0.01-1.0 mM;
(b) a macromolecular oncotic agent having a size sufficiently large to limit escape from the circulation system and effective to maintain oncotic pressure equivalent to that of blood plasma and selected from the group consisting of human serum albumin, polysaccharide and colloidal starch;
(c) a biological pH buffer effective under physiological and hypothermic conditions;
(d) a nutritive effective amount of at least one simple sugar;
(e) an impermeant and hydroxyl radical scavenging effective amount of mannitol;
(f) an impermeant anion impermeable to cell membranes and effective to counteract cell swelling during cold exposure, the impermeant ion being at least one member selected from the group consisting of lactobionate, gluconate, citrate and glycerophosphate-like compounds;
(g) a substrate effective for the regeneration of ATP, the substrate being at least one member selected from the group consisting of adenosine, fructose, ribose and adenine;
(h) at least one agent which regulates cellular levels of free radicals; and
(i) at least one gelling agent.

31. The gel-based medium composition according to claim 30, further comprising at least one agent which inhibits apoptosis.

32. The gel-based medium composition according to claim 30, wherein the gelling agent is selected from the group consisting of gelatin, carrageenan, agarose, collagen and plant-based gelling agents.

33. The gel-based medium composition according to claim 30, wherein the transport or storage of cell samples occurs at a temperature ranging from about −196° C. to about 37° C.

34. The gel-based medium composition according to claim 30, wherein the cell samples are obtained from a source selected from the group consisting of plants, animals, fungi, and microbes.

35. The gel-based medium composition according to claim 34, wherein the source of the cell samples is a fetal, neonatal, juvenile or adult animal.

36. The gel-based medium composition according to claim 34, wherein the cell samples are obtained from humans.

37. The gel-based medium composition according to claim 30, the plurality of electrolytes further comprising magnesium ions at a concentration ranging from about 0.1-10 mM.

38. The gel-based medium composition according to claim 30, wherein the gel-based composition preserves the cell samples when cooled to a chilled or frozen state.

39. The gel-based medium composition according to claim 30, wherein the cell samples are selected from the group consisting of a plurality of pancreatic islet cells; a plurality of stem cells; and a plurality of liver cells.

40. A method for increasing a storage duration of a cell sample at frozen temperatures, the method comprising:
a) forming a cell pellet;
b) mixing the pellet with a cell preservation medium comprising a cryopreservant, the cell preservation medium not containing a gelling agent;
c) adding a medium comprising a gelling agent to the cell pellet, the medium comprising the gelling agent being in a liquid state when added; and
d) reducing the temperature of the resulting mixture until the mixture gels; and storing the gelled mixture at a temperature below 0° C.;
wherein at least one agent that inhibits apoptosis is part of the medium selected from the group consisting of the cell preservation medium; the medium comprising the gelling agent; and both the cell preservation medium and the medium comprising the gelling agent.

41. The method of claim 40 wherein the gelled mixture is stored at a temperature of below 0° C. to −196° C.

42. The method of claim 40 wherein the cell sample is obtained from a source selected from the group consisting of plants, animals, fungi and microbes.

43. The method of claim 40 wherein the source of the cell sample is a fetal, neonatal, juvenile or adult animal.

44. The method of claim 40 wherein the cell sample is a human cell sample.

45. The method of claim 40 wherein the cell preservation medium comprises one or more electrolytes selected from the group consisting of potassium ions at a concentration ranging from about 10-145 mM, sodium ions ranging from about 10-120 mM, magnesium ions ranging from about 0.1-10 mM, and calcium ions ranging from about 0.01-1.0 mM.
